(19) United States
(12) Patent Application Publication
(10) Pub. No.: US 2004/0062599 A1
(43) Pub. Date: Apr. 1, 2004

(54) Arrangement for detachably connecting two components abutting against each other in a flush manner

(76) Inventor: Guido Koch, Karlsruhe (DE)

Correspondence Address: McCormick Paulding & Huber, City Place ll, 185 Asylum Street, Hartford, CT, 06103-3402, US

(21) Appl. No.: 10/467,224

(22) PCT Filed: Mar. 8, 2002
(86) PCT No.: PCT/EP02/02575

(30) Foreign Application Priority Data
Mar. 9, 2001 (DE) 101 11 442.7

(51) Int. Cl. F16B 1/00

(52) U.S. Cl. 403/382

(57) ABSTRACT

The invention relates to an arrangement for detachably connecting two construction parts (10, 24) abutting against each other in a flush manner, the first construction part (10) comprising a dovetail groove and the second construction part (24) comprising at least one sliding block (36) for engaging in the dovetail groove (32). After being introduced into the dovetail groove (32), the sliding block can be adjusted by means of a tensioning device (46) to tighten the abutting surfaces (22, 30) of the two components (10, 24) against each other. The inner surfaces (62) and the outer surfaces (64) of groove legs (34) defining the dovetail groove (32) are parallel to each other. Abutment surfaces (68 or 70) for the groove legs (34) are formed in the abutting surface (30) of the construction part carrying the sliding block (36) and are parallel to the outer surfaces (64) and the end surfaces (66) of the groove legs (34).

The invention concerns an arrangement for the releasable connection of two construction parts which buttingly engage one another, a first of which construction parts has a dovetail groove and the second of which parts has a slide piece designed for receipt in the dovetail groove and which after its insertion into the dovetail groove is adjustable by means of a tensioning device to clamp the two parts together with their abutment surfaces.

A dovetail groove is customarily an undercut groove wherein the inner surfaces of the groove legs defining the groove form a sharp angle with the base of the groove. The slide piece has a complementary shape. In a known solution the parts to be connected engage one another by means of abutment surfaces which run essentially parallel to the base of the groove. The slide piece is adjusted, for example by means of a tension screw, perpendicularly to these abutment surfaces, to clamp the two parts to one another by means of their abutment surfaces. Thereby the inclined surfaces of the slide piece exert on the inclined inner surfaces of the groove legs a spreading force so that the groove legs upon the tightening of the tension screw are pressed outwardly. A similar effect is obtained if a moment about an axis parallel to the longitudinal direction of the groove is applied to one of the two parts relative to the other. In this case on one side of the slide piece a force is applied pulling the slide piece away from the base of the groove, which through the inclined surfaces of the slide piece and of the associated groove leg which lie on one another causes the latter to be pressed outwardly. This can lead to a permanent deformation of this groove leg and in the worst case also to a tearing of the slide piece out of the dovetail groove.

The invention has as its object the provision of a connecting arrangement of the above-mentioned kind wherein neither by the tensioning of the slide piece nor by a loading of one of the construction parts by a rotational moment about an axis parallel to the longitudinal direction of the groove can the groove legs of the dovetail groove be bent outwardly or can an elastic deformation of the groove legs lead to a relative movement of the construction parts.

This object is solved in accordance with the invention in that the inner surfaces and the outer surfaces which define the groove legs of the dovetail groove are each parallel to one another and in that in the abutment surface of the slide piece carrying construction part support surfaces are formed parallel to the outer surfaces and the end surfaces of the groove legs for supporting the groove legs.

The solution of the invention results in that upon the tensioning of the slide piece the groove legs are not pressed outwardly but instead are pressed against the support surfaces of the slide piece carrying construction part. The groove legs are therefore clamped between the slide piece and the associated abutment surfaces. In this way they can neither by tensioning of the slide piece nor by the exertion of a rotational moment onto the construction part carrying the slide piece about an axis parallel to the groove direction be deflected outwardly. A rotational moment applied to this construction part is conducted through a support surface lying against the end face of one groove leg into that groove leg and thereby a rotation of the construction parts about the intersection point of the normal to the leg flanks is avoided. Thereby damage to the groove legs and a tearing of the slide piece out of the dovetail groove is avoided with assurance.

Preferably the slide piece is adjustably guided, in a recess in the abutment surface of the second construction part, perpendicularly to this abutment surface and has a threaded bore which receives a tension screw abutting the second construction part. This makes possible a reliable clamping of the slide piece.

The solution of the invention is especially suitable for an application wherein the first construction part is a patient support surface to one longitudinal end of which the second construction part, for example a head support plate, is attachable. Although such a patient support surface is only relatively thin and the support surfaces provided for the connection of the two construction parts to be buttingly connected with one another is small, by means of the connection arrangement of the invention a reliable, stiff and stable connection is assured. To be able to accommodate the slide piece and the tension screw on the head support plate, the head support plate advantageously has a connection beam which is parallel to the end or abutment surface of the patient support plate having the dovetail groove and in which at least one slide piece and its associated tension screw is supported.

Further features and advantages of the invention will be apparent from the following description, which in combination with the accompanying drawings explain the invention by way of an exemplary embodiment. The drawings are:

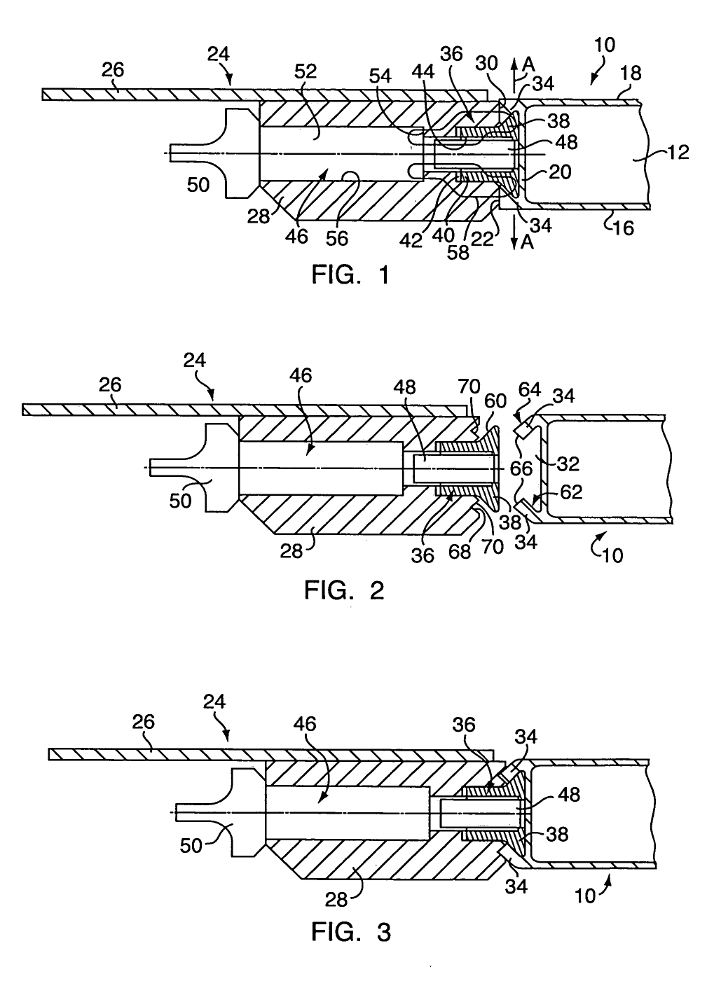

FIG. 1—a schematic partial sectional view through the connection station between a patient support surface and a head support plate taken perpendicular to the plane of the plate and perpendicular to the one another bordering surfaces of the two construction parts in a solution according to the state of the art,

FIG. 2—a sectional view corresponding to that of FIG. 1 through an end of a patient support surface and a head support plate in separated condition corresponding to the solution of the invention, and

FIG. 3—a sectional view corresponding to FIG. 1 taken through a connection arrangement according to the invention with the construction parts connected with one another.

In FIG. 1 a patient support plate is indicated at 10. It includes a foam material core 12 and a box-shaped shell 14, made of carbon fiber reinforced plastic material, with a bottom 16, a cover 18 and a slide wall 20 connecting the bottom and cover with one another.

At the outer or end surface 22 at the longitudinal end of the patient support plate 10 is attached a head support plate indicated generally at 24. This includes the actual plate 26 and a connector beam 28 which with an abutment surface 30 lies against the end surface 22 of the patient support plate 10. In the sidewall 20 is formed a dovetail groove 32, which is bounded by two groove legs 34. Received in the dovetail groove 32 is a slide piece indicated generally at 36, which slide piece has a head 38, corresponding to the groove cross section, and a shaft 40, which shaft is received in a recess 42 formed in the connector beam 28. The slide piece 36 has a threaded bore 44 perpendicular to the abutment surface 30 which receives a threaded portion 48 of a through going tension screw 46 in the connector beam 28. The tension screw 48 has a hand grip 50 and abuts by means of an enlarged diameter section 52 a shoulder 54 of its receiving bore 56 in the connector beam 28.

If in the case of the illustrated known solution of FIG. 1, the tension screw 46 is tightened, the slide piece 36 in FIG. 1 is pulled to the left, that is away from the base of the dovetail groove 32, with the inclined surfaces 60 on the rear side of the head 38 becoming pressed against the parallel inner surfaces 62 of the groove legs 34. The thereby appearing force path inside of the construction parts 10 and 24 to be connected with one another is as represented by the line 58. As will be seen, the bending of the force lines inside of the groove legs 34 effects a spreading force on the groove legs 34 directed outwardly in the direction of the arrow A, so that the dovetail groove 32 is widened. Further, if a moment about an axis parallel to the groove longitudinal direction, that is perpendicular to the plane of the drawing, is exerted downwardly onto the head support plate 24 in the direction of the arrow B, then at least the upper groove leg 34 will have exerted onto it a spreading force likewise effective in the direction of the arrow A, which in the case of an overloading of the head support plate can lead to a permanent deformation of the groove leg 34 or can even tear the slide piece 36 from the dovetail groove 32.

This disadvantage is avoided by the solution of the invention which is illustrated in FIGS. 2 and 3, wherein similar parts are indicated by the same reference numbers as in FIG. 1. In the solution of the invention, the groove legs 34 are so prepared on their outer sides that the outer 64 surface of each groove leg is parallel to its associated inner surface 62 and so that each leg has an end surface 66 perpendicular to the outer surface. Further in the abutment surface 30 of the connector beam 28 for each groove leg 34 a support surface 68 parallel to the surfaces 62 and 64 of the groove leg and a support surface 70 parallel to the end face 66 is provided against which respectively the outer side 64 and the end face 66 of the associated groove leg 34 lie when the two construction parts 10 and 24 are connected with one another as is illustrated in FIG. 3. From this one will understand that after the tightening of the slide piece 36 by the tightening of the tension screw 46 the groove legs 34 become clamped between the surface 60 on the head 38 of the slide piece 36 and the associated support surfaces 68 and 70 on the connector beam 28. The clamping or tensioning forces which hold the groove legs 34 are effective perpendicularly to the surfaces 62, 64 and 66. The groove legs 34 can no longer deflect outwardly. This is true both in respect to the tension forces exerted by the slide piece 36 and also in regard to the rotational moment which appears upon a loading of the head support plate 24 in the direction of the arrow B. The introduction of a rotary moment would in the case of a missing abutment of the support surfaces 70 lead to a rotary movement of the connector beam, which in turn would result in an out shifting of one groove leg and an in shifting of the other groove leg. This is prevented by the abutting of the groove legs onto the support surfaces 70. In this way even relatively thin construction parts can be reliably connected with one another along relatively smaller abutment surfaces without the danger existing of the connection being broken by heavier loads.

1. An arrangement for the releasable connection of two construction parts (10, 12) buttingly engaging one another, of which the first construction part (10) has a dovetail groove and the second construction part (24) has at least one slide piece (36) designed for insertion into the dovetail groove (32), which slide piece after its insertion into the dovetail groove (32) is adjustable by means of a tension device (46) to clamp the two construction parts (10, 12) to one another by their abutment surfaces (22, 30), characterized in that the inner surfaces (62) and the outer surfaces (64) of the groove legs (34) defining the dovetail groove (32) are parallel to one another and that in the abutment surface (30) of the slide piece (36) carrying construction part (24) support surfaces (68 and 70) are formed for the groove legs (34) which are parallel to the outer surfaces (64) and the end surfaces (66) of the groove legs (34).

2. An arrangement according to claim 1 further characterized in that the slide piece (36) is adjustably guided in a recess (42) of the support surface (30) of the second construction part (34) perpendicularly to the abutment surface (30) and has a threaded bore (44) in which is received a tension screw (46) abutting the second construction part (24).

3. An arrangement according to claim 1 or 2, further characterized in that the first construction part (10) is a patient support plate to one longitudinal end of which the second construction part (24) is attachable.

4. An arrangement according to claim 3, further characterized in that the second construction part (24) is a head support plate.

5. An arrangement according to claim 4, further characterized in that the head support plate (24) has a connector beam (28) parallel to the end wall (20) of the patient support plate (10) having the dovetail groove (32) and in which beam the at least one slide piece (36) and its associated tension screw (46) are supported.
